(19) United States
(12) Patent Application Publication
(10) Pub. No.: US 2016/0277729 A1
(43) Pub. Date: Sep. 22, 2016

(54) IMAGE PROCESSING APPARATUS, METHOD FOR OPERATING SAME, AND SYSTEM COMPRISING SAME

(71) Applicant: SAMSUNG ELECTRONICS CO., LTD., Gyeonggi-do (KR)

(72) Inventors: Jin Ho LEE, Suwon-si (KR); Ju Yong PARK, Suwon-si (KR); Seo Young CHOI, Suwon-si (KR); Dong Kyung NAM, Suwon-si (KR)

(73) Assignee: SAMSUNG ELECTRONICS CO., LTD., Suwon-si (KR)

(21) Appl. No.: 15/037,932

(22) PCT Filed: May 2, 2014
(86) PCT No.: PCT/KR2014/003913

§ 371 Date: May 19, 2016

(30) Foreign Application Priority Data
Nov. 19, 2013 (KR) 10-2013-0140732

(51) Int. Cl. H04N 13/04; H04N 9/31

(52) U.S. Cl. CPC H04N 13/0459; H04N 9/3185

(57) ABSTRACT

Provided are an image processing device, a method for operating the image processing device, and a system including the image processing device. A method of generating an image of a display system including a projector may include determining first external parameters of the projector, determining second external parameters of the projector in accordance with a variation of the projector, comparing the first external parameters and the second external parameters and calculating a variation amount corresponding to the variation of the projector, and generating a modified input image of the projector on the basis of the variation amount.

### CROSS-REFERENCE TO RELATED APPLICATION

The present Application is a National Stage entry under 35 U.S.C. §371 of International Application PCT/KR2014/003913, filed May 2, 2014, which claims priority from Korean Patent Application No. 10-2013-0140732, filed in the Korean Patent Office on Nov. 19, 2013.

### BACKGROUND

1. Field

Apparatuses and methods consistent with exemplary embodiments relate to an image processing device, an operating method of the image processing device, and a system including the image processing device.

2. Description of the Related Art

Recently, glasses type three-dimensional (3D) televisions (TVs) and glasses-free type 3D TVs have become common as 3D content is becoming more readily available.

Glasses type 3D TVs may provide 3D images to users wearing polarized glasses, which may inconvenience the users by requiring them to wear the glasses, and may cause fatigue during viewing due to an accommodation-vergence conflict.

Glasses-free type 3D TVs may utilize a viewpoint-based imaging method of providing a multi-view image using a lenticular lens, and the like to display a 3D image, or may utilize a light field-based imaging method of recombining two-dimensional (2D) images separately generated using a scheme of synthesizing light field rays to provide a 3D image.

In a system utilizing the viewpoint-based imaging method, the resolution of a display decreases based on the number of generated viewpoints, and therefore, the viewing angle and viewing distance are limited.

A system utilizing the light field-based imaging method may increase the number of projectors disposed corresponding to directional components of light and may secure a required resolution to realize a high-resolution 3D image.

### SUMMARY

One or more exemplary embodiments may provide a technology of measuring extrinsic parameters of a projector based on a variation of the projector.

One or more exemplary embodiments may provide a technology of calculating a variation amount corresponding to the variation of the projector based on a measurement result, calibrating an input image of the projector based on the variation amount and generating a clear three-dimensional (3D) image.

According to an aspect of an exemplary embodiment, there is provided an image generation method of a display system including a projector, the image generation method including determining at least one first extrinsic parameter of the projector, determining at least one second extrinsic parameter of the projector based on a variation of the projector, calculating a variation amount corresponding to the variation of the projector by comparing the at least one first extrinsic parameter and the at least one second extrinsic parameter, and generating a modified input image of the projector based on the variation amount.

The calculating of the variation amount may include calculating a rotation angle variation amount corresponding to the variation of the projector by comparing a rotation angle component of the at least one extrinsic parameter and a rotation angle component of the at least one second extrinsic parameter.

The generating of the modified input image may include rotating the input image in a reverse direction by the rotation angle variation amount and calibrating the input image.

The generating of the modified input image may include rotating a virtual projector corresponding to the projector by the rotation angle variation amount, acquiring a virtual projection image of the virtual projector using a virtual camera, the virtual projection image being rotated based on the rotating of the virtual projector, and rendering an image acquired using the virtual camera and generating the modified input image.

The variation may include at least one of a change in a position of the projector and a change in an orientation of the projector.

The determining the at least one second extrinsic parameter of the projector may include calculating the at least one second extrinsic parameter of the projector based on at least one intrinsic parameter of a camera included in the display system, at least one first extrinsic parameter of the camera, and at least one projection characteristic of the projector.

The image generation method may further include determining at least one second extrinsic parameter of the camera based on a variation of the camera. The determining of the at least one second extrinsic parameter of the projector may include determining the at least one second extrinsic parameter of the projector based on the at least one intrinsic parameter of the camera, the at least one second extrinsic parameter of the camera, and the at least one projection characteristic of the projector.

The determining of the at least one first extrinsic parameter of the projector may include measuring the at least one first extrinsic parameter of the projector when the projector is initially installed in the display system.

The determining of the at least one second extrinsic parameter of the projector may include projecting, by the projector, a checkerboard pattern onto a white board installed in a position of a screen, the checkerboard pattern having a size equal to or less than half a size of the screen, and acquiring a projection image of the projector using a camera included in the display system, analyzing the acquired projection image and thereby determining the at least one second extrinsic parameter of the projector.

According to an aspect of another exemplary embodiment, there is provided a display system including a projector configured to project light corresponding to an input image, and an image processing device configured to determine at least one first extrinsic parameter of the projector based on a variation of the projector, to compare the at least one first extrinsic parameter and at least one second extrinsic parameter of the projector measured in advance in the display system, to calculate a variation amount corresponding to the variation of the projector, and to generate a modified input image based on the variation amount.

The image processing device may include a parameter determining unit configured to determine the at least one first extrinsic parameter based on the variation of the projector, an image calibration unit configured to compare the at least one first extrinsic parameter and the at least one second extrinsic parameter, to calculate the variation amount, to calibrate a virtual projection image corresponding to the input image based on the variation amount, and to acquire the calibrated virtual projection image, and an image generation unit configured to generate the modified input image based on an image acquired by the image calibration unit.

The image calibration unit may be configured to compare a rotation angle component of the at least one first extrinsic parameter and a rotation angle component of the at least one second extrinsic parameter, to calculate a rotation angle variation amount corresponding to the variation of the projector, to rotate the virtual projection image by the rotation angle variation amount, and to calibrate the virtual projection image.

The image calibration unit may include a virtual projector configured to generate the virtual projection image, the virtual projector corresponding to the projector, a control logic configured to compare the at least one first extrinsic parameter and the at least one second extrinsic parameter, to calculate the variation amount and to rotate the virtual projector in a reverse direction by the variation amount, and a virtual camera configured to acquire the virtual projection image rotated based on rotating of the virtual projector.

The variation may include at least one of a change in a position of the projector and a change in an orientation of the projector.

The parameter determining unit may be configured to determine the at least one first extrinsic parameter and the at least one second extrinsic based on at least one intrinsic parameter of a camera, at least one extrinsic parameter of the camera, and at least one projection characteristic of the projector.

The extrinsic parameters of the camera may be parameters measured based on a variation of the camera.

### BRIEF DESCRIPTION OF THE DRAWINGS

These and/or other exemplary aspects and advantages will become apparent and more readily appreciated from the following description of the exemplary embodiments, taken in conjunction with the accompanying drawings in which:

FIG. 1 is a block diagram illustrating a display system according to an exemplary embodiment.

FIG. 2 is a block diagram illustrating the display device of FIG. 1.

FIG. 3 is a block diagram illustrating the image processing device of FIG. 1.

FIG. 4 is a diagram illustrating a scheme of measuring extrinsic parameters of a camera in the parameter measuring unit of FIG. 3.

FIG. 5 is a diagram illustrating a scheme of measuring extrinsic parameters of a projector in the parameter measuring unit of FIG. 3.

FIG. 6 is a block diagram illustrating the image calibration unit of FIG. 3.

FIG. 7 is a diagram illustrating an operation of the image calibration unit of FIG. 6.

FIGS. 8A through 8D are diagrams illustrating a scheme of generating an input image of a projector based on a variation of a projector.

FIG. 9 is a flowchart illustrating an operating method of the image processing device of FIG. 1.

### DETAILED DESCRIPTION

Hereinafter, exemplary embodiments will be described in detail with reference to the accompanying drawings.

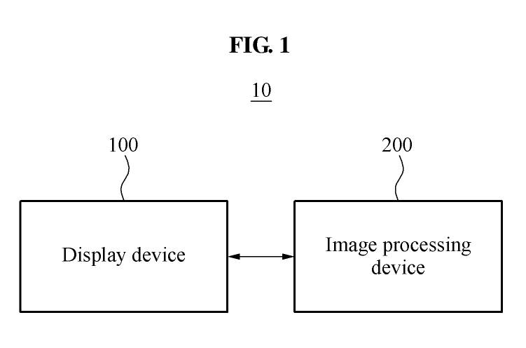

FIG. 1 is a block diagram illustrating a display system according to an exemplary embodiment.

Referring to FIG. 1, a display system 10 includes a display device 100 and an image processing device 200. The display system 10 may be a glasses-free three-dimensional (3D) display system.

The display device 100 may generate a 3D image based on an input image received from the image processing device 200. The input image may be, for example, a two-dimensional (2D) image or a 3D image. The display device 100 may be a light-field 3D display device.

The image processing device 200 may control the overall operation of the display system 10. The image processing device 200 may be implemented as an integrated circuit (IC), a system on chip (SoC) or a printed circuit board (PCB), for example, a motherboard. The image processing device 200 may be, for example, a memory and an application processor which operates according to software recorded in the memory.

The image processing device 200 may generate an input image and transmit the input image to the display device 100 so that the display device 100 may generate a 3D image based on the input image. Also, the image processing device 200 may calculate a variation amount corresponding to a variation of a projector included in the display device 100, and may generate the input image based on the variation amount. The input image may be, for example, an image calibrated in accordance with the variation amount.

The image processing device 200 is shown in FIG. 1 as separate from the display device 100, however, this is not required. Depending on the embodiment, the image processing device 200 may be included in the display device 100.

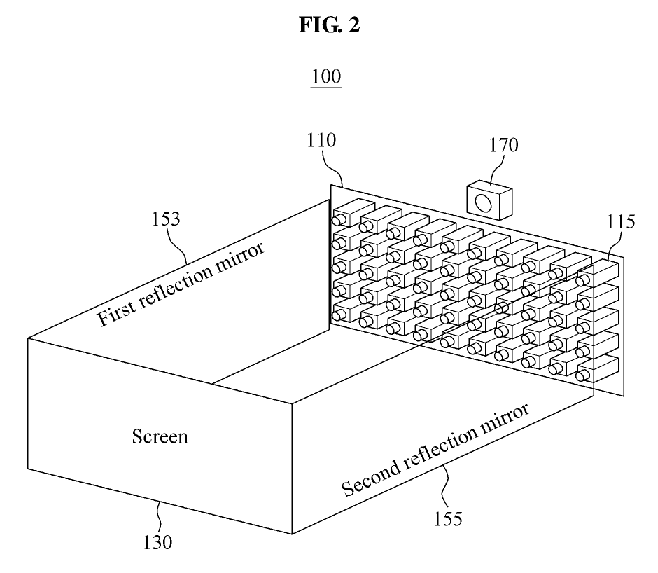

FIG. 2 is a block diagram illustrating the display device 100 of FIG. 1.

Referring FIGS. 1 and 2, the display device 100 may include a projector array 110, a screen 130, a plurality of reflection mirrors, for example, a first reflection mirror 153 and a second reflection mirror 155, and a camera 170.

The projector array 110 may include a plurality of projectors 115.

Operations of the plurality of projectors 115 are substantially the same, and accordingly, a single projector will be described from FIG. 2 for convenience of description.

Each projector 115 may emit at least one ray corresponding to an input image received from the image processing device 200. The input image may be, for example, an input image for forming a light field image, a multi-view image or a super multi-view image as a 3D image. The input image may be a 2D image or a 3D image.

Each projector 115 may be an optical module that is a microdisplay including a spatial light modulator (SLM).

The screen 130 may display the at least one ray projected from the plurality of projectors 115. For example, a 3D image generated by synthesizing or overlapping the at least one ray may be displayed on the screen 130. The screen 130 may be a vertical diffusing screen.

The screen 130 may reflect light and the first reflection mirror 153 and the second reflection mirror 155 may reflect the light, reflected from the screen 130, among light projected from the projector 115 back into the screen 130.

The first reflection mirror 153 may be disposed in one side, for example, a left side of the screen 130, and may reflect toward the screen light projected to the left side of the screen 130. The second reflection mirror 155 may be disposed on another side, for example, a right side of the screen 130, and may reflect toward the screen light projected to the right side of the screen 130.

In an example, each of the first reflection mirror 153 and the second reflection mirror 155 may be disposed between the projector array 110 and the screen 130 and may include a reflection surface oriented substantially perpendicular to each of the projector array 110 and the screen 130. For example, a first end of the first reflection mirror 153 may be adjacent to the projector array 110, and another end of the first reflection mirror 153 may be adjacent to the screen 130, and the first reflection mirror itself may be perpendicular to both the projector array 110 and the screen 130. Also, one end of the second reflection mirror 155 may be adjacent to the projector array 110, and another end of the second reflection mirror 155 may be adjacent to the screen 130, and the second reflection mirror 155 may be perpendicular to both the projector array 110 and the screen 130.

In another example, the reflection surfaces of first reflection mirror 153 and the second reflection mirror 155 may tilt at a predetermined angle from a center of the screen 130. In other words, a first end of the first reflection mirror 153 may form a first angle with the projector array 110, and another end of the first reflection mirror 153 may form a second angle with the screen 130. One end of the second reflection mirror 155 may form a third angle with the projector array 110, and another end of the second reflection mirror 155 may form a fourth angle with the screen 130. For example, the first angle and the third angle may be the same or different. The second angle and the fourth angle may be the same or different. The first reflection mirror 153 and the second reflection mirror 155 may tilt at the predetermined angle from the screen 130, and may reflect rays projected by the projector 115 toward the screen 130. For example, the predetermined angle may be set.

The camera 170 may capture or acquire an image displayed on the screen 130. The camera 170 may transmit the captured or acquired image to the image processing device 200.

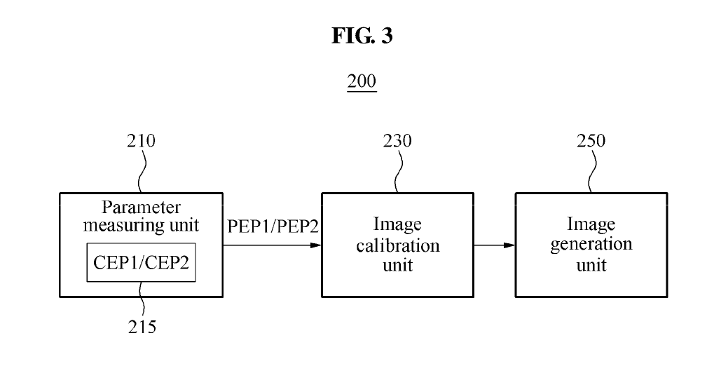

FIG. 3 is a block diagram illustrating the image processing device 200 of FIG. 1.

Referring to FIGS. 1 and 3, the image processing device 200 may calculate a variation amount corresponding to a variation of the projector 115, and may generate an input image of the projector 115 based on the variation amount.

The image processing device 200 may include a parameter measuring unit 210, an image calibration unit 230, and an image generation unit 250.

The parameter measuring unit 210 may measure camera extrinsic parameters (CEP) CEP1 and CEP2 of the camera 170. The parameter measuring unit 210 may measure first extrinsic parameters CEP1 of the camera 170. For example, when the camera 170 is initially installed in the display system 10, for example, the display device 100, the parameter measuring unit 210 may measure the first extrinsic parameters CEP1 of the camera 170. The parameter measuring unit 210 may measure second extrinsic parameters CEP2 of the camera 170 based on a variation of the camera 170. The variation may include at least one of a position variation or an orientation variation of the camera 170 and/or a fixing portion of the camera 170. By using substantially the same method, the first extrinsic parameters CEP1 and the second extrinsic parameters CEP2 of the camera 170 may be measured. The first extrinsic parameters CEP1 may include parameters measured earlier than the second extrinsic parameters CEP2, in addition to parameters measured when the camera 170 is initially installed. The first extrinsic parameters CEP1 may be, for example, parameters measured in advance in the display device 100.

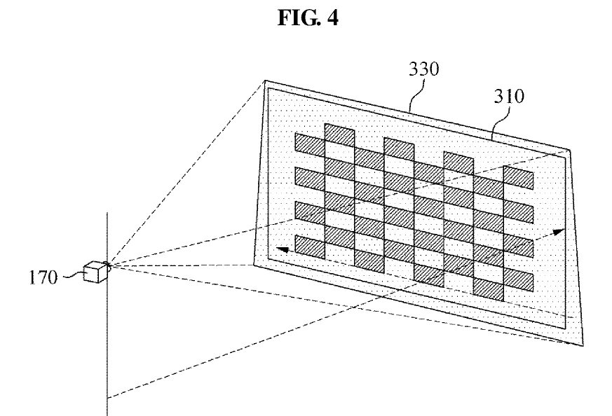

FIG. 4 is a diagram illustrating a scheme of measuring extrinsic parameters of a camera in the parameter measuring unit 210 of FIG. 3.

Referring to FIG. 4, the camera 170 may generate a pattern image 330 by capturing a checkerboard pattern of a checkerboard 310 installed in place of the screen 130. The checkerboard 310 may be, for example, a reference screen disposed in a position corresponding to the position of the screen 130. The size of the checkerboard 310 may be the same as a size of the screen 130.

The parameter measuring unit 210 may correct a distortion of the pattern image 330 acquired using the camera 170, based on intrinsic parameters of the camera 170. For example, the intrinsic parameters may be measured outside the display device 100 before the camera 170 is installed in the display device 100. The intrinsic parameters may include, for example, a distortion coefficient or a camera matrix of the camera 170.

The parameter measuring unit 210 may extract, from the pattern image having corrected distortion, a feature point corresponding to an inner corner of the checkerboard pattern, and may calculate a direction vector of the extracted feature point with respect to an optical center of the camera 170. The parameter measuring unit 210 may measure the first extrinsic parameters CEP1 of the camera 170 based on the direction vector. For example, the first extrinsic parameters CEP1 of the camera 170 may include orientation parameters (for example, θx, θy, and θz) and position parameters (for example, x, y and z) of a camera 100 during initial installation of the camera 170.

The parameter measuring unit 210 may measure the second extrinsic parameters CEP2 of the camera 170 based on the variation of the camera 170 using the above-described method.

The parameter measuring unit 210 may include a memory 215. The memory 215 may store the first extrinsic parameters CEP1 and the second extrinsic parameters CEP2 of the camera 170. Also, the memory 215 may store intrinsic parameters of the camera 170 of the projector 115.

The parameter measuring unit 210 may measure projector extrinsic parameters (PEP) PEP1 of the projector 115. The parameter measuring unit 210 may measure first extrinsic parameters PEP1 of the projector 115. For example, when the projector 115 is initially installed in the display system 10, for example, the display device 100, the parameter measuring unit 210 may measure first extrinsic parameters PEP1 of the projector 115. The parameter measuring unit 210 may measure second extrinsic parameters PEP2 of the projector 115 based on the variation of the projector 115. The variation may include at least one of a position variation or an orientation variation of the projector 115 and/or an optical axis of the projector 115.

By using substantially the same method, the first extrinsic parameters PEP1 and the second extrinsic parameters PEP2 of the projector 115 may be measured. The first extrinsic parameters PEP1 may include parameters measured earlier than the second extrinsic parameters PEP2, in addition to parameters measured when the projector 115 is initially installed. For example, the first extrinsic parameters PEP1 may be parameters measured in advance in the display device 100.

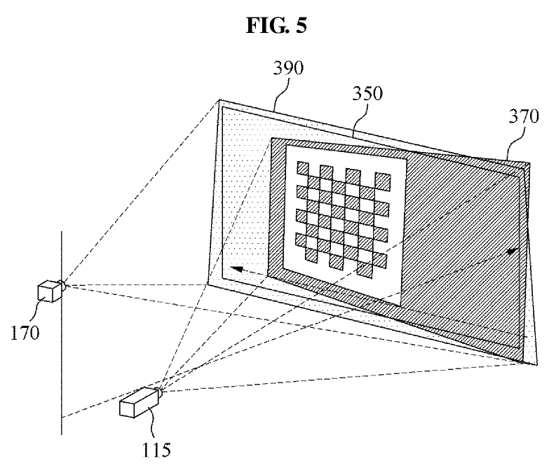

FIG. 5 is a diagram illustrating a scheme of measuring extrinsic parameters of a projector in the parameter measuring unit 210 of FIG. 3.

Referring to FIG. 5, the projector 115 may project a checkerboard pattern having a size equal to or less than half the size of the screen 130 onto a white board 350 installed in place of the screen 130. The checkerboard pattern may be input data or an input image of the projector 115. For example, the white board 350 may be a reference screen disposed in a position corresponding to the position of the screen 130.

As shown in FIG. 5, a projection image 370 of the projector 115 may be displayed on the white board 350.

The camera 170 may generate a pattern image 390 by capturing the checkerboard pattern of the projection image 370 displayed on the white board 350.

The parameter measuring unit 210 may correct the distortion of the pattern image 390 acquired using the camera 170 based on intrinsic parameters of the camera 170. The parameter measuring unit 210 may extract, from the pattern image 390 having corrected distortion, a feature point corresponding to an inner corner of the checkerboard pattern, and may calculate 3D coordinates of the extracted feature point based on the first extrinsic parameters CEP1 of the camera 170 and a projection characteristic of the projector 115. For example, the projection characteristic of the projector 115 may be measured outside the display device 100 before the projector 115 is installed in the display device 100. The projection characteristic of the projector 115 may include, for example, a projection image size and a projection distance of the projector 115. The projection characteristic may be stored in the memory 215.

The parameter measuring unit 210 may measure the first extrinsic parameters PEP1 of the projector 115 based on the 3D coordinates of the extracted feature point. For example, the first extrinsic parameters PEP1 may include orientation parameters (for example, θx, θy, and θz) and position parameters (for example, x, y and z) of the projector 115 during initial installation of the projector 115.

The parameter measuring unit 210 may measure the second extrinsic parameters PEP2 of the projector 115 based on the variation of the projector 115 using the above-described scheme. However, when the second extrinsic parameters CEP2 of the camera 170 are measured based on the variation of the camera 170, the parameter measuring unit 210 may measure the second extrinsic parameters PEP2 of the projector 115 based on the measured second extrinsic parameters CEP2, instead of the first extrinsic parameters CEP1 of the camera 170 in the above-described scheme. The second extrinsic parameters PEP2 of the projector 115 may include orientation parameters and position parameters of the projector 115 which may vary depending on the orientation and position of the projector 115.

The image calibration unit 230 may compare the first extrinsic parameters PEP1 and the second extrinsic parameters PEP2 of the projector 115, may calculate a variation amount corresponding to the variation of the projector 115, and may calibrate a virtual projection image corresponding to the input image of the projector 115 based on the variation amount. For example, the image calibration unit 230 may compare a rotation angle component of the first extrinsic parameters PEP1 and a rotation angle component of the second extrinsic parameters PEP2, may calculate a rotation angle variation amount corresponding to the variation of the projector 115, and may rotate and calibrate the virtual projection image by the rotation angle variation amount. In this example, the virtual projection image may be rotated in a direction opposite a direction of the rotation angle variation amount.

Also, the image calibration unit 230 may capture the calibrated virtual projection image.

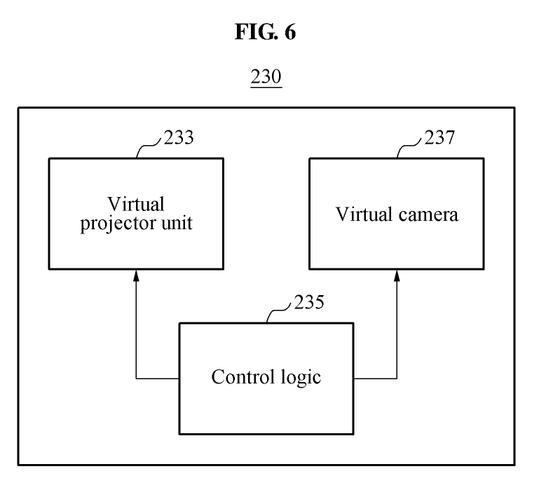

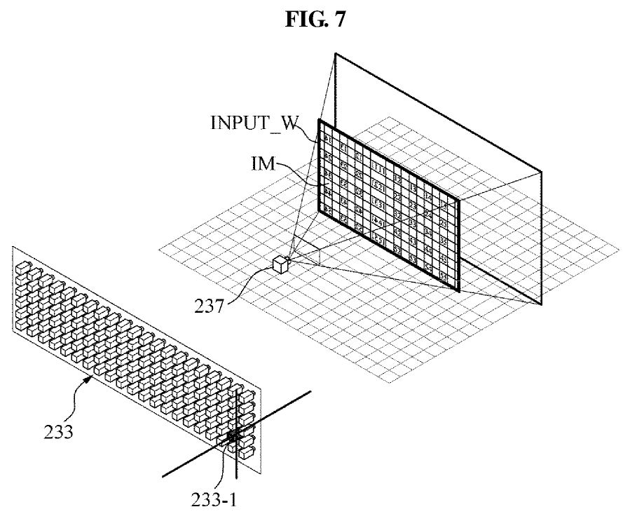

FIG. 6 is a block diagram illustrating the image calibration unit 230 of FIG. 3, and FIG. 7 is a diagram illustrating an operation of the image calibration unit 230 of FIG. 6.

Referring to FIGS. 6 and 7, the image calibration unit 230 may include a virtual projector unit 233, a control logic 235, and a virtual camera 237. The image calibration unit 230 may further include a memory (not shown). The memory may store the first extrinsic parameters PEP1 of the projector 115.

The virtual projector unit 233 may correspond to the projector array 110 of the display device 100. The virtual projector unit 233 may include a plurality of virtual projectors. For example, each of the plurality of virtual projectors in the virtual projector unit 233 may correspond to one of the plurality of projectors in the projector array 110.

A virtual projector 233-1 may project a virtual projection image IM corresponding to an input image of the projector 115. For example, the virtual projector 233-1 may project the virtual projection image IM onto an input image window INPUT_W. The virtual projector 233-1 may correspond to the projector 115. The image processing device 200 may project the virtual projection image IM corresponding to the input image onto the input image window INPUT_W using the virtual projector 233-1 corresponding to the projector 115, to verify a state of the input image before the input image is transmitted to the projector 115.

The control logic 235 may compare the first extrinsic parameters PEP1 and the second extrinsic parameters PEP2 of the projector 115, may calculate the variation amount corresponding to the variation of the projector 115, and may rotate the virtual projector 233-1 by the variation amount in a reverse direction. For example, the control logic 235 may compare a rotation angle component of the first extrinsic parameters PEP1 and a rotation angle component of the second extrinsic parameters PEP2, may calculate a rotation angle variation amount corresponding to the variation of the projector 115, and may rotate the virtual projector 233-1 the rotation angle variation amount in a reverse direction by. By rotating the virtual projector 233-1, the virtual projection image IM displayed on the input image window INPUT_W may rotate. For example, the virtual projection image IM may rotate in the reverse direction based on the rotating of the virtual projector 233-1.

The virtual camera 237 may acquire the virtual projection image IM of the virtual projector 233-1, and may transmit the acquired image to the image generation unit 250. For example, the virtual camera 237 may acquire the virtual projection image IM rotated by the rotating of the virtual projector 233-1, and may transmit the acquired image to the image generation unit 250.

The image generation unit 250 may generate an input image of the projector 115. The image generation unit 250 may generate the input image based on an image acquired by the virtual camera 237. The virtual projection image IM, rotated based on the rotating of the virtual projector 233-1, may be acquired. For example, the image generation unit 250 may render the acquired image, and may generate the rendered image as the input image. The image generation unit 250 may be implemented by, for example, a graphics real-time rendering module.

When the image processing device 200 generates the input image of the projector 115 based on the variation of the projector 115, the display device 100 may generate a clear 3D image based on the input image regardless of the variation of the projector 115.

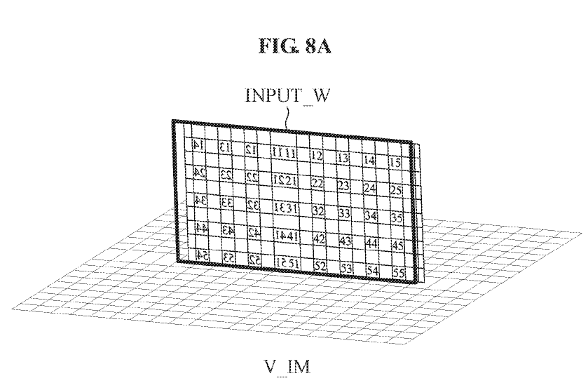

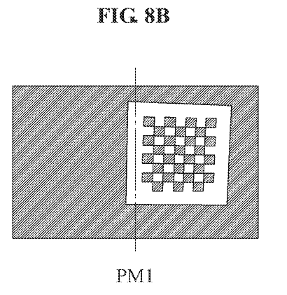

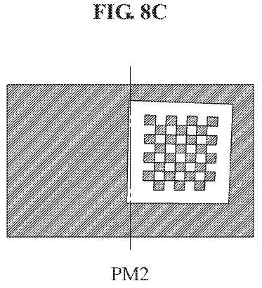

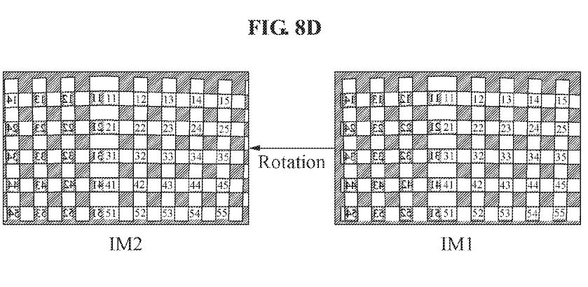

FIGS. 8A through 8D are diagrams illustrating a scheme of generating an input image of a projector based on a variation of the projector.

Referring to FIGS. 8A through 8D, the parameter measuring unit 210 may measure the second extrinsic parameters PEP2 of the projector 115 based on the variation of the projector 115. For example, the parameter measuring unit 210 may measure the second extrinsic parameters PEP2 of the projector 115 based on intrinsic parameters of the camera 170, extrinsic parameters (for example, the first extrinsic parameters CEP1 or the second extrinsic parameters CEP2) of the camera 170, and the projection characteristic of the projector 115. An image PM2 may be a pattern image including a checkerboard pattern captured by the camera 170 when the parameter measuring unit 210 measures the second extrinsic parameters PEP2. An image PM1 may be a pattern image including the checkerboard pattern captured by the camera 170 when the parameter measuring unit 210 measures the first extrinsic parameters PEP1. For example, a size of the checkerboard pattern may be equal to or less than half the size of the screen 130.

A method by which the parameter measuring unit 210 measures the second extrinsic parameters PEP2 may be substantially the same as the method described above with reference to FIG. 5.

The parameter measuring unit 210 may transmit the measured second extrinsic parameters PEP2 of the projector 115 to the image calibration unit 230, for example, the control logic 235.

A current virtual projection image V_IM, corresponding to the input image to be transmitted to the projector 115 based on the variation of the projector 115, may be displayed on an input image window INPUT_W as shown in FIG. 8A.

The control logic 235 may compare the first extrinsic parameters PEP1 and the second extrinsic parameters PEP2 of the projector 115, and may calculate the variation amount corresponding to the variation of the projector 115. For example, the control logic 235 may compare a rotation angle component of the first extrinsic parameters PEP1 and a rotation angle component of the second extrinsic parameters PEP2, and may calculate a rotation angle variation amount corresponding to the variation of the projector 115.

The control logic 235 may rotate the input image of the projector 115 by the variation amount, for example, the rotation angle variation amount, corresponding to the variation of the projector 115, but in a reverse direction, to calibrate the input image. For example, the control logic 235 may rotate the virtual projector 223-1, corresponding to the projector 115, by the rotation angle variation amount in a reverse direction. By rotating the virtual projector 223-1, the virtual projection image V_IM may be rotated by the rotation angle variation amount, in the reverse direction, and may be calibrated.

The virtual camera 237 may acquire the virtual projection image V_IM rotated by rotating the virtual projector 233-1, and may transmit the acquired image to the image generation unit 250.

The image generation unit 250 may render the image acquired by the virtual camera 237, and may generate a rendered image IM2 as the input image of the projector 115. An image IM1 may be an image rendered by the image generation unit 250 before an input image to be transmitted to the projector 115 is calibrated by the rotation angle variation amount corresponding to the variation of the projector 115.

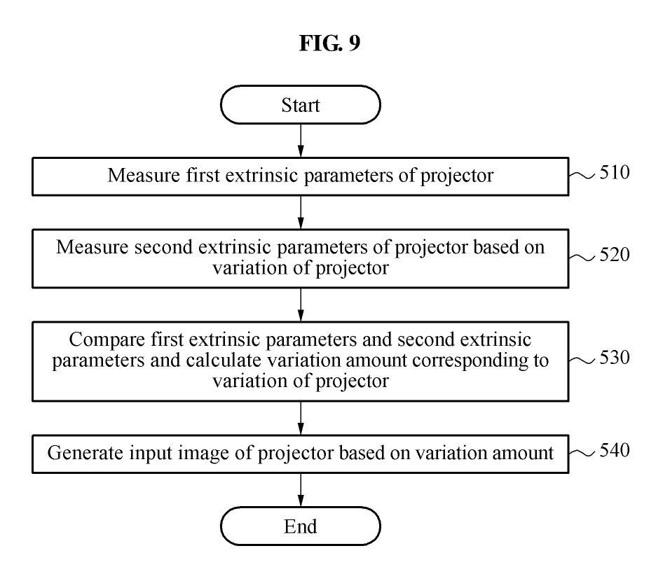

FIG. 9 is a flowchart illustrating an operating method of the image processing device 200 of FIG. 1.

Referring to FIG. 9, in operation 510, the image processing device 200 may measure the first extrinsic parameters PEP1 of the projector 115. In operation 520, the parameter measuring unit 200 may measure the second extrinsic parameters PEP2 of the projector 115 based on the variation of the projector 115.

In operation 530, the image processing device 200 may compare the first extrinsic parameters PEP1 and the second extrinsic parameters PEP2 of the projector 115, and may calculate the variation amount corresponding to the variation of the projector 115.

In operation 540, the image processing device 200 may generate the input image of the projector 115 based on the variation amount.

One or more methods according to the above-described exemplary embodiments may be recorded in a non-transitory computer-readable medium, and may include program instructions, which, when implemented by a computer cause the computer to perform various operations. The media may also include, alone or in combination with the program instructions, data files, data structures, and the like. The program instructions recorded on the media may be those specially designed and constructed for the purposes of the exemplary embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments, or vice versa.

Although a few exemplary embodiments have been shown and described, these are not intended to be limiting. Instead, it would be appreciated by those skilled in the art that changes may be made to these embodiments without departing from the principles and spirit of the inventive concept, the scope of which is defined by the claims and their equivalents.

1. An image generation method of a display system comprising a projector, the image generation method comprising:
determining at least one first extrinsic parameter of the projector;
determining at least one second extrinsic parameter of the projector based on a variation of the projector;
calculating a variation amount of the projector based on the at least one first extrinsic parameter and the at least one second extrinsic parameter;
generating a modified input image based on the variation amount;
transmitting the modified input image to the projector.

2. The image generation method of claim 1, wherein the calculating the variation amount comprises calculating a rotation angle variation amount by comparing a rotation angle component of the at least one first extrinsic parameter and a rotation angle component of the at least one second extrinsic parameter.

3. The image generation method of claim 2, wherein the generating modified input image comprises rotating an input image by the rotation angle variation amount and calibrating the input image.

4. The image generation method of claim 2, wherein the generating the modified input image comprises:
rotating a virtual projector by the rotation angle variation amount;
acquiring a virtual projection image of the virtual projector using a virtual camera, wherein the virtual projection image is rotated based on the rotating of the virtual projector; and
generating the modified input image based on the acquired virtual projection image.

5. The image generation method of claim 1, wherein the variation comprises at least one of a change in a position of the projector and or a change in an orientation of the projector.

6. The image generation method of claim 1, wherein the determining the at least one second extrinsic parameter of the projector comprises calculating the at least one second extrinsic parameter based on at least one intrinsic parameter of a camera included in the display system, at least one first extrinsic parameter of the camera, and at least one a projection characteristic of the projector.

7. The image generation method of claim 6, further comprising:
determining the at least one second extrinsic parameter of the camera based on a variation of the camera,
wherein the determining the at least one second extrinsic parameter of the projector comprises calculating the at least one second extrinsic parameter of the projector based on the at least one intrinsic parameter of the camera, the at least one second extrinsic parameter of the camera, and the at least one projection characteristic of the projector.

8. The image generation method of claim 1, wherein the determining the at least one first extrinsic parameter of the projector comprises measuring the at least one first extrinsic parameter of the projector when the projector is initially installed in the display system.

9. The image generation method of claim 1, wherein the determining the at least one second extrinsic parameter of the projector comprises:
the projector projecting a checkerboard pattern onto a white board installed in a position of a screen, wherein a size of the checkerboard pattern is equal to or less than half a size of the screen; and p1 acquiring a projection image of the projector using a camera included in the display system, analyzing the acquired projection image and determining the at least one second extrinsic parameter of the projector based on the acquired projection image.

10. A display system comprising:
a projector configured to project light corresponding to an input image; and
an image processing device configured to determine at least one first extrinsic parameter of the projector based on a variation of the projector, to compare the at least one first extrinsic parameter of the projector and at least one second extrinsic parameter of the projector, to calculate a variation amount of the projector based on the at least one first extrinsic parameter of the projector and the at least one second extrinsic parameter of the projector, to generate a modified input image based on the variation amount, and to transmit the modified input image to the projector.

11. The display system of claim 10, wherein the image processing device comprises a memory and a processor configured to execute software stored on the memory and thereby operate as:
a parameter determining unit configured to determine the at least one first extrinsic parameter based on the variation of the projector;
an image calibration unit configured to compare the at least one first extrinsic parameter and the at least one second extrinsic parameter, to calculate the variation amount, to calibrate a virtual projection image based on the variation amount, and to acquire the calibrated virtual projection image; and
an image generation unit configured to generate the modified input image based on the calibrated virtual projection image acquired by the image calibration unit.

12. The display system of claim 11, wherein the image calibration unit is configured to calculate a rotation angle variation amount by comparing a rotation angle component of the at least one first extrinsic parameter of the projector and a rotation angle component of the at least one second extrinsic parameter of the projector and to rotate the virtual projection image by the rotation angle variation amount.

13. The display system of claim 11, wherein the image calibration unit comprises:
a virtual projector configured to generate the virtual projection image;
a control logic configured to compare the at least one first extrinsic parameter of the projector and the at least one second extrinsic parameter of the projector, to calculate the variation amount and to rotate the virtual projector by the variation amount; and
a virtual camera configured to acquire the virtual projection image rotated based on rotating of the virtual projector.

14. The display system of claim 10, wherein the variation comprises at least one of a change in a position of the projector and a change in an orientation of the projector.

15. The display system of claim 11, wherein the parameter determining unit is configured to measure the at least one first extrinsic parameter of the projector and the at least one second extrinsic parameter of the projector based on at least one intrinsic parameter of a camera, at least one extrinsic parameter of the camera, and at least one projection characteristic of the projector.

16. The display system of claim 15, wherein the at least one extrinsic parameter of the camera is determined based on a variation of the camera.

17. A non-transitory computer-readable storage medium storing a program, which, when executed by a processor, causes the processor to perform a method comprising:
determining at least one first extrinsic parameter of a projector of a display system;
determining at least one second extrinsic parameter of the projector based on a variation of the projector;
calculating a variation amount of the projector based on the at least one first extrinsic parameter of the projector and the at least one second extrinsic parameter of the projector;
generating a modified input image based on the variation amount; and
transmitting the modified input image to the projector.
